(19) United States
(12) Patent Application Publication
(10) Pub. No.: US 2026/0172450 A1
(43) Pub. Date: Jun. 18, 2026

(54) QUANTUM ENHANCED ZERO-TRUST NETWORK SECURITY

(71) Applicant: American Express Travel Related Services Company, Inc., New York, NY (US)

(72) Inventor: Hiranmayi Palanki, Tampa, FL (US)

(21) Appl. No.: 18/975,670

(22) Filed: Dec. 10, 2024

(51) Int. Cl. H04L 9/40; H04L 41/12

(52) U.S. Cl. CPC H04L 63/20; H04L 41/12

(57) ABSTRACT

Various embodiments are described relating to approaches for network segmentation of a computing infrastructure network using quantum computing techniques. In one example, a system comprises a digital computing device and a quantum computing device in data communication with the digital computing device. The system is configured to generate a network topology graph of a computing infrastructure network having multiple node devices. A max-cut partition for the network topology graph is determined based at least in part on weights assigned to communication pathways between the node devices. An optimized network segmentation of the network topology graph is generated by executing a quantum approximate optimization algorithm (QAOA) circuit based at least part on the max-cut partition for the network topology graph and the weights.

### BACKGROUND

Network segmentation is a network security technique that divides a network into smaller subnetworks. The smaller subnetworks can be used to logically partition the network into smaller, isolated segments. These smaller subnetworks can improve network security by limiting connectivity and limiting access to sensitive data or other network resources. Different network segmentation strategies can use a combination physical hardware or software.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a drawing of a network topology graph with a max cut partition of a computing infrastructure network according to various embodiments of the present disclosure.

FIG. 3 is a flowchart illustrating one example of functionality implemented as portions of a service executed in a digital computing environment in the network environment of FIG. 1 according to various embodiments of the present disclosure.

FIG. 4 is a flowchart illustrating one example of functionality implemented as portions of a service executed in a quantum computing environment in the network environment of FIG. 1 according to various embodiments of the present disclosure.

FIG. 5 is a flowchart illustrating one example of functionality implemented as portions of a service executed in a quantum computing environment in the network environment of FIG. 1 according to various embodiments of the present disclosure.

FIG. 6 is a flowchart illustrating one example of functionality implemented as portions of a service executed in a quantum computing environment in the network environment of FIG. 1 according to various embodiments of the present disclosure.

### DETAILED DESCRIPTION

The various embodiments of the present disclosure relate to approaches for network segmentation using quantum computing techniques. In some embodiments, the embodiments can include approaches for zero-trust network segmentation. Zero-trust network segmentation is a security method that divides a network into smaller segments to reduce the risk of unauthorized access to data. In a zero-trust model, no device, user, or application is automatically trusted, and each must be validated before accessing the network, a subnetwork, or components of the networks.

Network security continues to evolve to prevent unauthorized users from accessing sensitive data and networks. In some cases, industries form security standards (e.g., Payment Card Industry Data Security Standard, Healthcare Insurance Portability and Accountability Act) that need to be followed for companies to remain in good standing and for companies continue to participant in a particular industry. As malicious actors continue to evolve their security attack techniques, network standards and network policies also need to improve to maintain network security for organizations and their computing ecosystems.

Accordingly, various embodiments of the present disclosure use quantum computing techniques to generate and enforce more secure network segmentation configurations of a computing infrastructure network. These secure network segmentation configurations can provide further granularity for network security policies. Additionally, after being generated, the generated network segmentations can automatically be implemented in the computing infrastructure network. As such, the generated network segmentations can be dynamically created and applied for directing the network traffic within the computing infrastructure network without human intervention.

The various embodiments of the present disclosure provide technical advantages over existing methods of generating network segmentation configurations. For example, the unconventional arrangement of the quantum computing techniques provides for more granular network segmentation configurations and an automated network analysis for identifying vulnerabilities in network communication paths among other technical advantages. Further, the network segmentation configurations generated from the embodiments of the present disclosure are effective in mitigating lateral movement of malicious attackers and the spread of ransomware/malware in the computing infrastructure network. Additionally, the embodiments describe unconventional arrangement of quantum computing techniques that improve the computational speed for generating network segmentation configurations, which can include network partitions and network policies (e.g., access privileges for network devices, rules for controlling network traffic). Additionally, the unconventional arrangement of quantum computing techniques enable the generation of more granular network segmentation configurations that cannot be generated on traditional computing devices.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

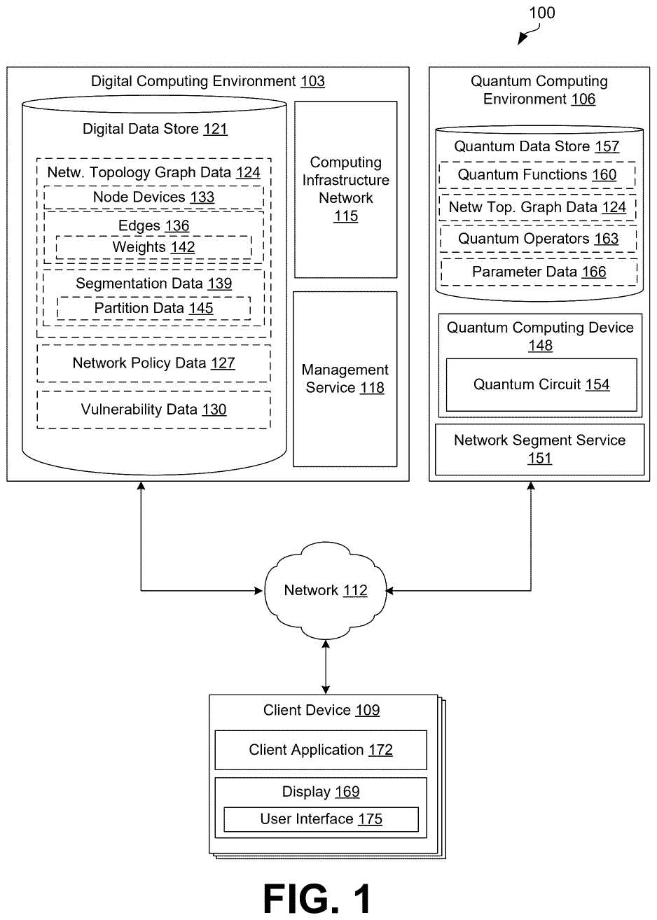

With reference to FIG. 1, shown is a network environment 100 according to various embodiments. The network environment 100 can include a digital computing environment 103, a quantum computing environment 106, and a client device 109, which can be in data communication with each other via a network 112.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The digital computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the digital computing environment 103 can employ a plurality of computing devices that can be arranged in one or more server banks or computer banks or other arrangements. Such computing devices can be located in a single installation or can be distributed among many different geographical locations. For example, the digital computing environment 103 can include a plurality of computing devices that together can include a hosted computing resource, a grid computing resource or any other distributed computing arrangement. In some cases, the digital computing environment 103 can correspond to an elastic computing resource where the allotted capacity of processing, network, storage, or other computing-related resources can vary over time.

Additionally, the digital computing environment 103 can include a computing infrastructure network 115 for representing a collection of computing hardware, software, and other components that enable communication, connectivity, and data transfer between devices, users, and applications within the digital computing environment 103 and to the network 112. The computing infrastructure network 115 can include a collection of subnetworks, firewalls (e.g., hardware and software component), routers, switches, hubs, gateways, bridges, and other suitable networking hardware/software components. The computing infrastructure network 115 can employ one or more network segmentation policies for controlling the network traffic coming in from the network 112 and for controlling the network traffic within the computing infrastructure network 115. The network segmentation policies (hereafter referred to as “network policies”) can be implemented one or more components of the computing infrastructure network 115. The network policies can include rules for controlling network traffic, access privileges needed to access network partition, network segments, subnetworks, and other suitable portions of the computing infrastructure network 115.

Various applications or other functionality can be executed in the digital computing environment 103. The components executed on the digital computing environment 103 include a management service 118, and other applications, services, processes, systems, engines, or functionality not discussed in detail herein.

The management service 118 can be executed to generate and enforce optimized network segmentations and/or network policies for the computing infrastructure network 115. The network segmentations and/or network policies can be enforced to control network traffic coming in from the network 112 and to control the network traffic within the computing infrastructure network 115. The network segmentations and/or network policies can restrict access to data and network devices within the digital computing environment 103. For example, the generated network policies can include rules for controlling the flow of network traffic, access level privileges or permissions for particular network segments, and other suitable components of network policies.

Also, various data is stored in a digital data store 121 that is accessible to the digital computing environment 103. The digital data store 121 can be representative of a plurality of data stores, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the digital data store 121 is associated with the operation of the various applications or functional entities described below. This data can include network topology graph data 124, network policy data 127, vulnerability data 130, and potentially other data.

The network topology graph data 124 can represent data associated with one or more network topology graphs for the computing infrastructure network 115. A network topology graph can be representative of the computing infrastructure network 115 or a portion of the computing infrastructure network 115. The network topology graph data 124 can include node devices 133, edges 136, segmentation data 139, and other suitable data. Each network topology graph can be represented in a data structure, such as a vector, an array, and other suitable data structures.

The node devices 133 can be representative of the computing devices (e.g., servers, endpoints, switches, routers, edge device, mobile devices, client devices, etc.) that are connected on the computing infrastructure network 115. The node devices 133 can include device characteristic data associated with each computing device, such as an Internet Protocol (IP) address, Internet bandwidth, device type, and other suitable networked computing device data.

The edges 136 can be representative of communication pathways between individual node devices 133 on the computing infrastructure network 115. The edges 136 can include edge properties such as bandwidth, bandwidth utilization, IP addresses, communication type (e.g., wireless, wired, etc.), and other suitable network data. The edges 136 can also include data associated with the weights 142. The weights 142 can represent a network security score or security classification of the vulnerabilities of the particular communication pathway.

The segmentation data 139 can be representative of data associated with one or more network segmentation configurations for the computing infrastructure network 115. The segmentation data 139 can include partition data 145 which represents one or more partitions that have been generated for the computing infrastructure network 115. For example, a partition can include dividing the node devices 133 into two or more subsets. The subsets can be isolated from each other on the computing infrastructure network 115 where access may be checked before being granted to access another subset. For example, a first node device 133 in a first subset may need to an access privilege or credential in order to access a second node device 133 in a second subset, where each subset are in different network segments (e.g., implemented using subnetworks, firewalls, etc.). In some examples, the partition can represent two or more subnetworks of the computing infrastructure network 115.

The network policy data 127 can represent data associated one or more configuration settings for implementing a network policy. In some examples, the embodiments of the present disclosure can generate the network policies as part of the generating the optimized network segmentation. The network policies can include creating subnetworks, assigning node devices to subnetworks, determining access privileges for a subnetwork, rules for controlling network traffic, and other network suitable network policies.

The vulnerability data 130 can represent data associated with one or more network security vulnerabilities that have been identified for a network communication pathway between node devices 133. The vulnerability data 130 can include signatures of malicious attacks, signatures of zero-day attacks, and other malicious security data. The vulnerability data 130 can be used by the quantum computing environment 106 to execute simulations. The simulations can be used for determining weights 142 of the edges 136, which can be used to optimized network segmentation and the network policies. In some examples, the network security vulnerabilities can be defined or represented as edges 136 with properties such as unpatched systems, zero-days, critical/high risk vulnerabilities with exploits.

The quantum computing environment 106 can include one or more quantum computing devices 148 (e.g., devices configured to process quantum data formatted as “quantum bits” also called “qubits”) that include a quantum processor, a quantum memory, and/or a network interface. The quantum computing devices 148 can be referred to as a “quantum-based” or “qubit-based” computing architecture that performs operations using quantum bits or qubits that can represent multiple states at a given time for information storage and manipulation. The software executed using quantum computing devices 148 can also be referred to as “quantum-based,” or “qubit-based,” and can use qubit-based operations. The qubit can be considered a basic unit of information in quantum computing and quantum communications. The qubit can be maintained based at least in part on the spin of electron or polarization of a photon. The quantum computing devices 148 can be configured to perform quantum computations on behalf of other computing devices (e.g., digital computing devices) or applications (e.g., network segment service 151, etc.). In some embodiments, quantum computing devices 148 can host and/or provide content to other computing devices (e.g., digital computing devices, digital computing environment 103, or quantum computing devices) in response to requests for content.

In various examples, a quantum computing device 148 can include a quantum circuit 154 which corresponds to a model for quantum computation that can be performed by the quantum computing device 148 to carry out the computation of the qubits. The quantum circuit 154 of the present disclosure is designed to optimize the network segmentation in a network topology graph taking into account network security vulnerabilities of the edges 136 (e.g., communication pathways between node devices 133), each edge 136 having potentially having varying severity of security risks, dependencies, and other network exposure. In various examples, the quantum circuit 154 includes a collection of interconnected quantum gates which are used in the transformations on the qubits. In various examples, the quantum circuit 154 can comprise Hadamard gates, phase separate gates, mixing gates, and/or other types of quantum gates. The Hadamard gate comprises a quantum logic gate that is used for the initialization of the quantum circuit 154 to create a superposition of all possible states (e.g., network segmentation configurations). A phase separator gate is a quantum logic gate that can be used to apply phase shifts passed on the maximum cut problem's cost function, effectively “penalizing” undesirable configurations. A mixing gate is a quantum logic gate that can be used to explore different configurations by rotating qubits around specific axes (e.g., Z and X rotations) during each iteration.

The quantum computing environment 106 can also include one or more digital computing devices (e.g., devices configured to process traditional binary and/or bitwise data and process) that include a digital processor, a digital memory, and/or a network interface. For example, the digital computing devices can be configured to perform non-quantum computations on behalf of other digital computing devices or applications. As another example, such digital computing devices can host and/or provide content to other computing devices (e.g., digital computing devices or quantum computing devices) in response to requests for content. As another example, such digital computing devices can request that other computing devices (e.g., digital computing devices or quantum computing devices) provide content in response to a request by the digital computing device. In such an example, the digital computing device can receive the content from the other computing devices (e.g., digital computing devices or quantum computing devices) or from some other source. By having both digital computing devices and quantum computing devices 148 on the quantum computing environment 106, the digital computing devices can act as an intermediary between other computing devices and the quantum computing devices 148, facilitating the execution of the necessary quantum processing with the quantum computing devices 148.

Moreover, the quantum computing environment 106 can employ a plurality of digital computing devices and/or quantum computing devices 148 that can be arranged in one or more server banks or computer banks or other arrangements. Such digital computing devices or quantum computing devices 148 can be located in a single installation or can be distributed among many different geographical locations. For example, the quantum computing environment 106 can include a plurality of digital computing devices and/or quantum computing devices 148 that together can include a hosted computing resource, a grid computing resource, or any other distributed computing arrangement. In some cases, the quantum computing environment 106 can correspond to an elastic computing resource, where the allotted capacity of processing, network, storage, or other computing-related resources can vary over time.

Various data can be stored in a quantum data store 157 that is accessible to the quantum computing environment 106. The quantum data store 157 can be representative of a plurality of quantum data stores 157, which can include relational databases or non-relational databases, such as object-oriented databases, hierarchical databases, hash tables, or similar key-value data stores, as well as other data storage applications, or data structures. Moreover, combinations of these databases, data storage applications, and/or data structures can be used together to provide a single, logical, data store. In various embodiments, the data stored in the quantum data store 157 can be structured as digital bits, representing how a qubit can be configured to represent the data. In other various embodiments, the data stored in the quantum data store 157 can store the data as a quantum state for easy retrieval by the quantum computing device 148. By storing the data as a quantum state, portions of the data can be stored in a quantum superposition, representing one or more possible states of the data. The data stored in the quantum data store 157 is associated with the operation of the various applications or functional entities described below. This data can include the network topology graph data 124, quantum functions 160, quantum operator 163, parameter data 166, and potentially other data.

Similar to the digital data store 121, the network topology graph data 124 can represent data associated with one or more network topology graphs for the computing infrastructure network 115 in the quantum data store 157. A network topology graph can be representative of the computing infrastructure network 115 or a portion of the computing infrastructure network 115. The network topology graph data 124 can include node devices 133, edges 136, segmentation data 139, and other suitable data. Each network topology graph can be represented in a data structure, such as a vector, an array, and other suitable data structures. The network topology graph data 124 can transmitted to the quantum computing environment 106 by the management service 118.

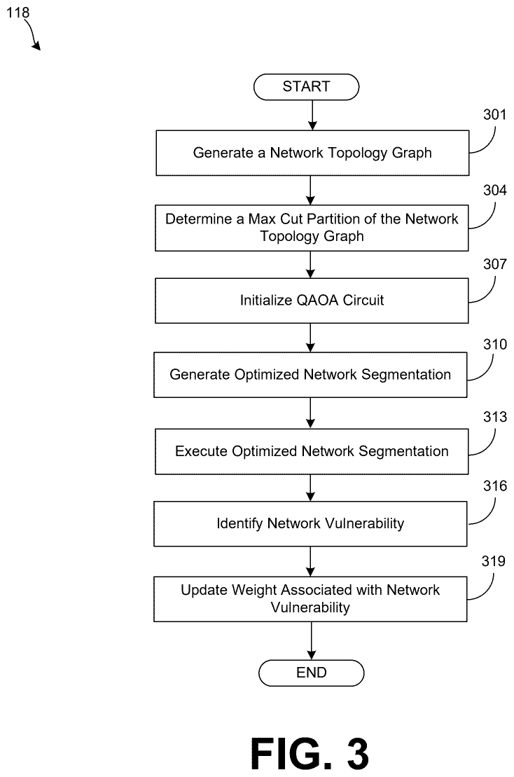

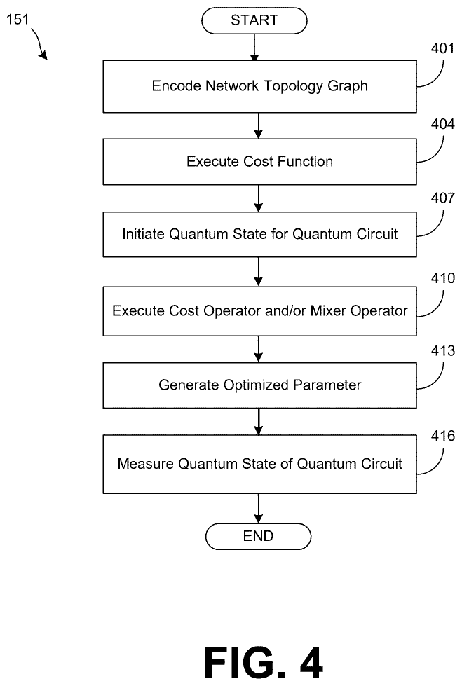

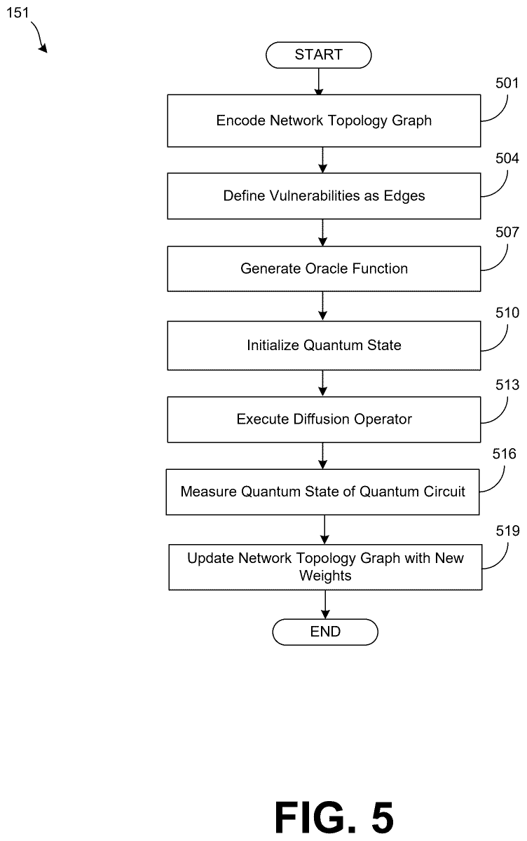

The quantum function 160 can represent one or more software functions that are executed by the quantum computing device 148 and/or the quantum circuit 154. Some non-limiting examples of a quantum function 160 can include a cost function (e.g., FIGS. 3 and 4), an oracle function (e.g., FIGS. 4 and 5), and other suitable quantum functions. A quantum function can be implemented as a software function that is executed to determine a representation of a quantum state and can be used to describe the probability of finding a particle in a certain location at a given time. For example, a cost function can be executed, as a software function, to generate a mathematical representation that quantifies the difference between predicted outcomes and actual outcomes in a given model. The cost function can be minimized to identify the most accurate set of parameters (e.g., network segmentation partitions, network policies, etc.) for a system (e.g., network topology graph) being analyzed. For example, the goal of the cost function can be to minimize the overall network security risk in a network topology graph by evaluating the network security risk represented in the edges 136 (e.g., communication pathways) between the node devices 133.

The quantum operators 163 can represent components of the quantum circuit 154. Different quantum circuits 154 may include different quantum operators. Some non-limiting examples can include a cost operator, a mixer operator, a diffusion operator (e.g., a Grover diffusion operator), and other suitable quantum operators. In some examples, the cost operator can be implemented as a diagonal operator on a qubit. Each diagonal entry can correspond to a specific solution's cost. A mixer operator can generate superpositions of the computational basis states. In one non-limiting example, a QAOA quantum circuit 154 can include a mixer operator and a cost operator.

The parameter data 166 can represent data associated with one or parameters that are provided as input to the quantum circuit 154 and/or generated as optimized output from the quantum circuit 154. Some non-limiting example parameters can include the network topology graphs, partitions, node devices 133, edges 136, weights 143, and other suitable quantum parameters.

Various applications or other functionality can be executed in the quantum computing environment 106. The components executed on the quantum computing environment 106 can include a network segment service 151, a quantum computing device 148 and other applications, services, processes, systems, engines, or functionality not discussed in detail herein.

The network segment service 151 can be executed for using one or more quantum computing techniques to determine network segmentation tasks and simulations. In various examples, the network segment service 151 can generate an optimized network segmentation of the network topology graph by executing a quantum circuit 154 (e.g., a quantum approximate optimization algorithm (QAOA) quantum circuit, a Grover quantum circuit, a Monte Carlo simulation circuit, etc.) based at least part on a max-cut partition for the network topology graph and the weights 142 associated with the network topology graph. In some examples, the max-cut partitions can be determined and provided by the management service 118 based at least in part on a network topology graph of the computing infrastructure network 115 for an organization. In other examples, the network segment service 151 can generate the network topology graph, the max cut partition, and other suitable parameters for executing the quantum circuit in order to generate an optimized network segmentation.

In various examples, the network segment service 151 can be executed to identify a network vulnerability for at least one of the edges 136 (e.g., network communication pathways) by executing a quantum circuit 154 (a Grover search quantum circuit 154) based at least in part on the optimized network segmentation. The network vulnerability can be represented as an updated weight 142 for the edge 136.

In various examples, the network segment service 151 can identify additional network vulnerabilities using simulations executed using a quantum circuit 154 (e.g., Monte Carlo simulations). The identified additional network vulnerabilities that can be used to update the weights 142 for the edges 136 (e.g., the communication pathways) between node devices 133.

The client device 109 is representative of a plurality of client devices that can be coupled to the network 112. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays 169, such as liquid crystal displays (LCDs), gas plasma-based flat panel displays, organic light emitting diode (OLED) displays, electrophoretic ink (“E-ink”) displays, projectors, or other types of display devices. In some instances, the display 169 can be a component of the client device 109 or can be connected to the client device 109 through a wired or wireless connection.

The client device 109 can be configured to execute various applications such as a client application 172 or other applications. The client application 172 can be executed in a client device 109 to access network content served up by the digital computing environment 103 or other servers, thereby rendering a user interface 175 on the display 169. To this end, the client application 172 can include a browser, a dedicated application, or other executable, and the user interface 175 can include a network page, an application screen, or other user mechanism for obtaining user input. The client device 109 can be configured to execute applications beyond the client application 172 such as email applications, social networking applications, word processors, spreadsheets, or other applications.

Next, a general description of the operation of the various components of the network environment 200 is provided. To begin, the client device 109 of a user (e.g., network security engineer, IT personnel, etc.) can display a user interface 175 that provides information and control components for controlling the performance of the computing infrastructure network 115. In some examples, the user interface 175 can include a segmentation optimization component for initializing the management service 118 to optimize the network segmentation of the computing infrastructure network 115.

In response to the selection of the segmentation optimization component, the management service 118 can scan the computing infrastructure network 115 to generate a network topology graph. The scan can collect data on various computing devices (e.g., servers, switches, edge devices, endpoint, routers, mobile devices, personal computers, network firewalls, etc.), device properties (e.g., connections, IP addresses, device type, etc.), software features (e.g., operating systems installed, communication pathways (e.g., connectivity, bandwidth utilization), and other suitable network data properties. The scan can involve using one more network discovery techniques, such as polling node devices 133 (e.g., networked devices) for device and network properties. As such, the generated network topology graph can include node devices 133 and the edges 136 that connect two node devices 133.

Next, the management service 118 can determine a max cut partition of the network topology graph based at least in part on the edges 136 and the network topology graph. In some examples, the max cut partition can represent a way to divide the network topography graph's node devices 133 into two sets to maximize value of the summation of the weights 142 for the edges 136.

The management service 118 can request that the quantum computing environment 106 generate an optimized network segmentation of the network topography graph. The request can be transmitted as an application programming interface (API) message to the network segment service 151. The request can include the network topology graph (e.g., in a data structure that represents the network topology graph), an instruction for generating the optimized network segmentation, the nodes 133, the edges 136, the weights 142, and other suitable data.

In the quantum computing environment 106, the network segment service 151 can execute one or more quantum computing techniques using a quantum circuit 154 for generating the optimized network segmentation. As will be described, the embodiments describe an unconventional arrangement of quantum computing techniques for generating network segmentation. For example, the quantum circuit 154 can be configured to use a quantum approximation optimization algorithm (QAOA) quantum computing technique, a Grover search quantum computing technique, and other suitable quantum computing techniques for generating network segmentations based at least in part on the input parameters provided by the management service 118.

For instance, the QAOA quantum computing technique can be used by a quantum circuit 154 to generate the optimized network segmentation based at least in part on the network topology graph, the edges 136, the weights 142, and other suitable parameters. From being provided these parameters, the quantum circuit 154 can generate an optimized network segmentation. The optimized network segments can be obtained by measuring the quantum state of the quantum circuit 154. Additionally, in some examples, the optimized network segments can be further optimized by the network segment service configuring a quantum circuit 154 to searching for vulnerable edges 136 in the optimized network segment. For example, the quantum circuit 154 can execute a Grover search quantum computing technique to identify the most vulnerable edges 136 in the optimized network segment. The network segment service 151 can update the weights 142 associated with the vulnerable edges 136 identified from the Grover search quantum computing technique. Subsequently, the network segment service 151 can transmit the optimized network segmentation to the management service 118.

The management service 118 can enforce the optimized network segmentation within the computing infrastructure network 115. In some instances, the enforcement is executed automatically after received the optimized network segmentation from the network segment service 151 without human intervention. The enforcement causes a change in the flow of the network traffic within the computing infrastructure network 115 because the management service 118 can enforce rules and network partitions derived from the optimized network segmentation.

Further, the computing infrastructure network 115 can use the optimized network segmentation to improve network security by minimizing the ability of malicious attackers navigate within the computing infrastructure network 115 because of the optimized network partitions or subnetworks that have been generated. For example, the optimized network segmentation can be implemented as a configuration of multiple subnetworks within the computing infrastructure network 115, where subsets of node devices 133 placed within a particular subnetwork.

Additionally, the optimized network segmentation can include a generation of network policies. For example, the network policies can include generated access levels or permissions assigned to node devices 133. As such, the node devices 133 need the appropriate access levels to access particular portions of the computing infrastructure network 115 (e.g., subnetworks, firewalls, etc.).

Additionally, the management service 118 can transmit a request to the quantum computing environment 106 to execute one or more quantum simulation techniques (e.g., Monte Carl Simulations) for identifying security vulnerabilities in the edges 136. The quantum circuit 154 that executes the quantum simulation techniques can iteratively explore various simulations of network malicious scenarios to identify security vulnerabilities in the edges 136. The security vulnerabilities can be used to update the weights 142 of the network topology graph.

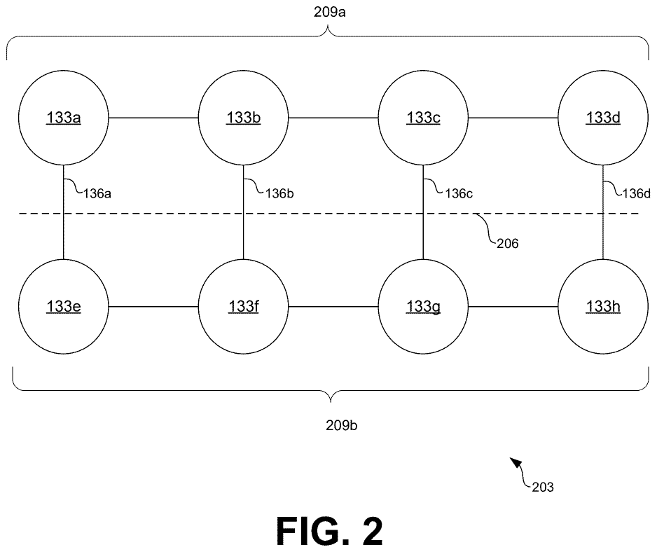

Referring next to FIG. 2, shown is drawing of a network topology graph 203 of multiple node devices 133 (collectively node devices 133a-133h can be referred to as “the node devices 133”). The network topology graph 203 includes a partition 206. The partition 206 divides the node devices 133 into a first subset 209a and a second subset 209b (collectively “the subsets 209” or individually “the subset 209”). In some examples, the partition is a max cut partition which is a way to divide the network topography graph's node devices 133 into two sets to maximize the summation of the edges 136 that intersect with the partition. As such, each edge 136 for the max cut partition 206 has an individual weight 142. The summation of the weights 142 from the set of edges 136a-136d is the maximum value for the network topology graph 203. As weights 142 change for the edges 136, then the max cut partition 206 could change as well. In the illustrated example, FIG. 2 displays the max cut partition 206 as intersecting edges 136a-136d (collectively referred to “the edges 136”).

Referring next to FIG. 3, shown is a flowchart that provides one example of the operation of a portion of the management service 118. The flowchart of FIG. 3 provides merely an example of the many different types of functional arrangements that can be employed to implement the operation of the depicted portion of the management service 118. As an alternative, the flowchart of FIG. 3 can be viewed as depicting an example of elements of a method implemented within the network environment 100.

Beginning with block 301, the management service 118 can generate a network topology graph of a computing infrastructure network 115 having a plurality of node devices 133. In some examples, the management service 118 can execute a scan or a discovery of computing infrastructure network 115 to generate network topology graph data 124. The discovery or scan process can identify network device information (e.g., device type, IP address, installed software, software version, geographic location, etc.), network connection information (e.g., network connection type (wired or wireless), link speed, port information, bandwidth utilization, bandwidth capacity, etc.), firewall data, subnetworks data, and other suitable network information. The management service 118 can use one or more techniques for executing the scan or discovery, such as a protocol-based discovery for querying network devices, an IP address scanning technique, a polling discovery technique, and other suitable techniques. In some examples, a user can manually specify the network topology graph data 124 for generating a network topology graph. In some examples, the network topology graph of the computing infrastructure network 115 can be represented as a visual network topology graph (e.g., FIG. 2). In other examples, the network topology graph can be represented as a data structure (e.g., an array, a vector, a matrix, etc.) that indicates the relationships (e.g., edges 136 or weights 142) between node devices 133.

In block 304, the management service 118 can determine a max-cut partition for the network topology graph based at least in part on weights 142 assigned to communication pathways (e.g., the edges 136 or weights 142) between the node devices. The max-cut partition can represent a cut or partition in the network topology graph that maximizes the total weights 142 of the edges 136 that are intersected. The max-cut partition generates two subsets 209 (e.g., a first subset 209a, a second subset 209b, etc.) from the network topology graph. The subsets can be generated to facilitate with the generation of the optimized network segmentation. The generation of the subsets 209 can be used to determine how the more vulnerable (e.g., high risk) node devices 133 should be separated from the less vulnerable (e.g., lower risk) node devices 133. In some examples, the first subset 209a can represent a first set of one or more node devices 133 that are more vulnerable on the computing infrastructure network 115 than a second set of one or more node devices 133 in the second subset 209b. In another example, the first subset 209a can represent the most vulnerable to a network attack and the second subset 209b can represent the least vulnerable to a network attack. As the weights 142 are updated, the management service 118 can generate an updated max cut partition, which can be stored in the digital data store 121.

In block 307, the management service 118 can initialize a quantum approximate optimization algorithm (QAOA) circuit (quantum circuit 154) by transmitting a request or an instruction, e.g., via an application programming interface (API), to the quantum computing environment 106 for generating an optimized network segmentation for the computing infrastructure network 115, such as an API or other suitable data protocol for interfacing with the quantum computing environment 106. The request can include an instruction for generating the optimized network segmentation, the network topology graph, the max cut partition, quantum circuit parameters and other suitable data/parameters for executing the request. Further discussion of the initialization of the QAOA circuit will be described in FIG. 4.

In block 310, the management service 118 can generate an optimized network segmentation of the network topology graph by executing the QAOA quantum circuit 154 based at least part on the max-cut partition for the network topology graph and the weights 142. In some examples, the quantum computing environment 106 can execute one or more tasks for a quantum approximate optimization algorithm, such as executing a quantum cost function, initializing a quantum state, executing cost and mixer operators, executing parameter optimization, measuring a quantum state of a quantum circuit 154, and other suitable quantum computing functionality. Further discussion of the generation of the optimized network segmentation will be described in FIG. 4. After being generated, the network segment service 151 of the quantum computing environment 106 can transmit the optimized network segmentation to the management service 118.

In block 313, the management service 118 can execute the optimized network segmentation in the computing infrastructure network 115. In some examples, the optimized network segmentation can include an updated partition, network policies, and other suitable network parameters/configurations. In some examples, the network policies can include a set of network conditions, network constraints, and network settings that define which node devices 133 can connect to certain portions of the computing infrastructure network 115 and under what conditions (e.g., permissions, authorization levels, etc.). In some examples, the network policies can include setting access permissions for one or more node devices 133 and other conditions for when a particular node device 133 can access a subnetwork, a firewall, or other suitable portions of the computing infrastructure network 115. The optimized network segmentation can be transmitted to one or more components (e.g., firewall, subnetwork, etc.) within the computing infrastructure network 115 with an instruction for execution. As such, network traffic can be directed within the computing infrastructure network based least in part on the optimized network segmentation being executed by at least one of a firewall or a subnetwork for the computing infrastructure network 115.

In some examples, the optimized network segmentation is automatically implemented based at least in part on receiving the optimized network segmentation from the quantum computing environment 106. In other examples, the optimized network segmentation can be displayed in a user interface 175. The optimized network segmentation can be executed after receiving an approval of a user on the user interface 175 via a selection of a user interface component.

In block 316, the management service 118 can identify a network vulnerability for at least one of the edges 136 (e.g., communication pathways) by executing a Grover search quantum circuit (e.g., a quantum circuit 154) based at least in part on the optimized network segmentation. The Grover search quantum circuit (e.g., a quantum circuit 154) can be executed by transmitting a request or an instruction via an API to the quantum computing environment 106. The request can include an instruction for identifying network vulnerabilities in the optimized network segmentation of the network topology graph. The network vulnerability is represented as an updated weight (e.g., an updated network security score or network risk level) for at least one of the edges 136 between the node devices 133. Further discussion of the execution of the Grover search quantum circuit will be described in FIG. 5. After being generated, the network segment service 151 of the quantum computing environment 106 can transmit the network vulnerabilities for the edges 136 to the management service 118.

In block 319, the management service 118 can update weights 142 associated with the identified network vulnerability in the network topology graph. The updated weights 142 can be stored in association with the network topology graph in the digital computing environment 103. Then, the management service 118 proceeds to the end.

Turning now to FIG. 4, shown is a flowchart that provides one example of the operation of a portion of the network segment service 151. The flowchart of FIG. 4 provides merely an example of the many different types of functional arrangements that can be employed to implement the operation of the depicted portion of the network segment service 151. As an alternative, the flowchart of FIG. 4 can be viewed as depicting an example of elements of a method implemented within the network environment 100.

Beginning with block 401, the network segment service 151 can encode the network topology graph into the quantum circuit 154, such as a quantum approximate optimization algorithm (QAOA) circuit or other suitable quantum circuits based at least in part on a request or an instruction received from the digital computing environment 103. The request can include an instruction for generating the optimized network segmentation, the network topology graph, the max cut partition, quantum circuit parameters and other suitable data/parameters for executing the request.

In some examples, the network segment service 151 can encode the network topology graph data 124 associated with the network topology graph into one or more qubits associated with the quantum circuit 154. As such, the network segment service 151 can encode within data (e.g., network topology graph data 124, edges 136, weights 142) include within qubits of the quantum circuit 154 (e.g., QAOA quantum circuit).

In some examples, the network segment service 151 uses an amplitude encoding technique for encoding data into the amplitude of a quantum state of a qubit. Other non-limiting examples can include a basis quantum encoding technique.

In block 404, the network segment service 151 can execute a cost function. In some examples, the cost function is defined, in which the intent is to minimize the defined cost function. In some examples, the network segment service 151 can define the cost function in order to quantify the network security risk for partitions, edges 136, and other suitable components of the network topology graph. The goal of the cost function is to minimize the weights 142 (e.g., the network security risks) for the communication pathways between the node devices 133. For quantum computing, the cost function is a problem-specific function that defines the goal of the optimizer to minimize. In some examples, the cost function can be represented as a mathematical representation that quantifies the difference between predicted outcomes and actual outcomes in a given model. By minimizing the cost function, the network segment service 151 can identify the most accurate variation of parameters for the system under consideration.

In some examples, the optimized network segmentation can be defined as a combinatorial optimization problem. The network topology graph is encoded to the quantum circuit 154. The weights 142 are adjusted based at least in part on the network security risk.

In block 407, the network segment service 151 can initiate a quantum state for the quantum circuit 154 based at least in part on the cost function. In some examples, the initialization refers to setting the qubits to a superposition state via the use of Hadamard gates. The quantum circuit 154 can be initialized to represent a superposition of all edge states (e.g., weights 142) of the security vulnerabilities represented in the network topology graph, with Hadamard gates applied to each qubit.

In block 410, the network segment service 151 can execute a cost operator and/or a mixer operator. The cost operator is executed to identify a phase shift associated with quantum gates for the quantum circuit 154. The phase shifts are used to iterate through the edges 136 and their corresponding weights 142. Cost operator is applied based at least in part on the cost function. The cost operator introduces phase shifts proportional to the weights 142 of the edges 136.

In some examples, the mixer operator is executed to evaluate one or more of the partitions for the network topology graph and applies one or more rotations. The mixer operator is applied to mix states and explore the optimized network segmentation space. The mixer operator can be comprised of rotation gates.

In block 413, the network segment service 151 can generate one or more optimized parameters by using a parameter optimization quantum algorithm. The input parameters for the algorithm can be provided from the cost operator, the mixer operator, and other suitable parameters to generate an optimized network segmentation in the quantum circuit 154. The input parameters are optimized with classical optimization algorithms. The objective is to find parameters that minimize the cost function. In some examples, the input parameters can be iteratively adjusted, via executing the quantum circuit 154, output is measured, and parameters are updated based on the measurement outcome.

In block 416, the network segment service 151 can measure the quantum state of the quantum circuit 154 based at least in part on the execution of the QAOA quantum circuit 154 (e.g., parameter optimization quantum algorithm). When the quantum state is measured, the network segment service 151 can obtain a binary string that represents a possible solution to network segmentation. The measured binary string is converted into a network partition and its cost is evaluated. The network segment service 151 can select the solution with the minimum cost as the optimized network segmentation for the computing infrastructure network 115. The network segment service 151 can transmit the optimized network segmentation to the management service 118. Then, the network segment service 151 can proceed to the end.

Moving on to FIG. 5, shown is a flowchart that provides one example of the operation of a portion of the network segment service 151. The flowchart of FIG. 5 provides merely an example of the many different types of functional arrangements that can be employed to implement the operation of the depicted portion of the network segment service 151. As an alternative, the flowchart of FIG. 5 can be viewed as depicting an example of elements of a method implemented within the network environment 100.

Beginning with block 501, the network segment service 151 can encode the network topology graph into the quantum circuit 154, such as a search circuit (e.g., Grover search circuit) or other suitable quantum circuits based at least in part on a request or an instruction received from the digital computing environment 103. The request can include an instruction for executing the quantum circuit 154 in order to identify network security vulnerabilities for the edges 136 (e.g., the communication pathways between the node devices 133), the network topology graph, the optimized network segmentation, quantum circuit parameters and other suitable data/parameters for executing the request.

In some examples, the management service 118 can transmit the request or the instruction to the network segment service 151 to initiate a Grover search execution automatically based at least in part on the identification of the optimized network segmentation (e.g., from FIG. 3 (313)). In other examples, the user interface can include a user interface component for triggering the Grover search execution. The user interface component can be available or visible after the optimized network segmentation has been generated.

In block 504, the network segment service 151 can define network security vulnerabilities as edges 136 of the network topology graph. The network security vulnerabilities can be defined or represented as edges 136 with properties such as unpatched systems, zero-days, critical/high risk vulnerabilities with exploits within the quantum circuit 154.

In block 507, the network segment service 151 can generate an oracle function for execution of a Grover search algorithm or technique. The oracle function can be a software function that can be defined and accessed by the quantum search function (e.g., implementing a Grover search algorithm) to provide information on quantum states. The oracle function can be defined to identify vulnerable edges 136 (e.g., communication pathways with network security risks that exceed a security threshold) in the network topology graph. The vulnerable edges 136 can be vulnerable to malicious attacks of unauthorized users. For example, the vulnerability edges 136 may be vulnerable to lateral movements of external threats and internal threats, exploitive initiatives of guest privileges, and other suitable malicious threats.

In block 510, the network segment service 151 can initialize a quantum state for a quantum circuit 154 that has been encoded. The oracle function can mark the states corresponding to vulnerable edges 136. In some examples, the oracle function can mark states as a vulnerable edge 136 when a vulnerable threshold is met.

In block 513, the network segment service 151 can execute a diffusion operator. The quantum state is initialized with qubits in superposition of all possible states. The oracle function is applied to mark the vulnerable states. A diffusion operator is applied to amplify the probability of the marked states. The oracle function and the diffusion operator can be iterated/repeated multiple times to increase the probability of measuring a vulnerable state for an edge 136.

In block 516, the network segment service 151 can measure a quantum state of the quantum circuit 154. Quantum state is measured to obtain the state corresponding to a potential vulnerability. The network segment service 151 can convert a Measured state into the corresponding edge 136 in the network topology graph.

In block 519, the network segment service 151 can update the network topology with the updated weights 142 from the quantum circuit 154. The weights 142 of the edges 136 are adjusted to reflect the increased or decreased risk in network security. The network segment service 151 can transmit the update weights 142 to the management service 118, which can be stored in the digital data store 121 and used for further optimization of the network segmentation of the computing infrastructure network 115. Then, the network segment service 151 proceeds to the end.

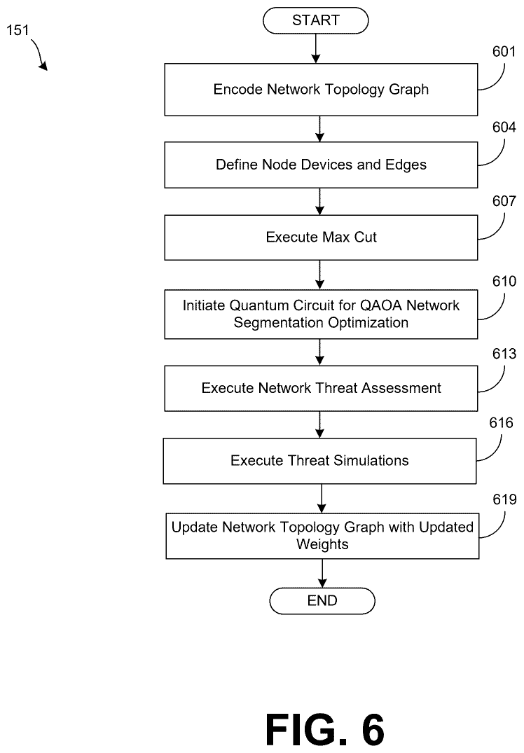

Moving on to FIG. 6, shown is a flowchart that provides one example of the operation of a portion of the network segment service 151. The flowchart of FIG. 6 provides merely an example of the many different types of functional arrangements that can be employed to implement the operation of the depicted portion of the network segment service 151. As an alternative, the flowchart of FIG. 6 can be viewed as depicting an example of elements of a method implemented within the network environment 100.

Beginning with block 601, the network segment service 151 can encode the network topology graph into the quantum circuit 154, such as a simulation quantum circuit 154 (e.g., a Monte Carlo quantum circuit) or other suitable quantum circuits based at least in part on a request or an instruction received from the digital computing environment 103. The request can include an instruction for executing a simulation quantum circuit 154 (e.g., Monte Carlo simulations) to identify network security vulnerabilities for the edges 136 (e.g., the communication pathways between the node devices 133), the network topology graph, the optimized network segmentation, quantum circuit parameters and other suitable data/parameters for executing the request.

In some examples, the management service 118 can transmit the request or the instruction to the network segment service 151 to initiate simulations automatically based at least in part on one or steps from the functionality of the flowchart for FIG. 3 (310) or other suitable triggering conditions. In other examples, the user interface can include a user interface component for triggering the simulation. The user interface component can be available or visible after the optimized network segmentation has been generated.

In block 604, the network segment service 151 can define the node devices 133 and the edges 136 for the quantum circuit 154. In some examples, the node devices 133 can include servers, containers, endpoints, mobile devices, and other suitable devices for designations as vertices. The edges 136 are representative of the communication pathways between the node devices 133. The network segment service 151 can assign the initial weights 142 based at least in part on risks, threats and vulnerabilities associated with the communication pathways.

In block 607, the network segment service 151 determine a maximum cut partition of the network topology graph based at least in part on the weights 142 assigned to the edges 136 (e.g., the communication pathways). In some examples, the network segment service 151 can define an objective function that is executed to maximize the sum of weights 142 of edges 136 between different partitions. The maximum cut partition can be determined to identify an initial network segmentation of the network topology graph.

In various examples, the network segment service 151 can define a max cut partition based at least in part on the network topology graph. Max cut partition splits the network topology graph into two disjoint sets such that the sum of the weights 142 of the edges 136 between the two sets is maximized. In some examples, the solution of the max cut partition can correspond to a partition where the most secure node devices 133 are placed on opposite sides of the cut of the most vulnerable node devices 133. In particular, a goal of the max cut partition is to partition the node devices 133 of the network topology graph into two sets to maximize the total weight 142 of the cut edges 136. In this example, max cut partition is identified when the network topology graph is partitioned into two disjoint sets such that the total weight 142 of the edges 136 between the two sets is maximized. This represents the objective function for the max cut partition, where maximizing the sum of weights 142 across the network topology graph partition helps identify network vulnerabilities that should be prioritized for segmentation.

In block 610, the network segment service 151 can initiate a quantum circuit for a quantum approximate optimization algorithm (QAOA) technique for network segmentation optimization. In some examples, the initialization refers to setting the qubits set to a superposition state via the use of Hadamard gates. The quantum circuit 154 can be initialized to represent a superposition of all edge states (e.g., weights 142) of the security vulnerabilities represented in the network topology graph, with Hadamard gates applied to each qubit.

In block 613, the network segment service 151 can execute a network threat assessment using a quantum circuit 154 configured for simulations, such as Monte Carlo simulation techniques. Monte Carlo simulation technique can be mathematical techniques that use repeated random sampling to predict the possible outcome of uncertain events. As such, iteratively random sampling the inputs to the quantum circuit 154 can be performed to identify network security vulnerabilities in the edges 136.

In block 616, the network segment service 151 can execute a threat simulation for generating updated weights 142. The updated weights 142 (e.g., network security risk score) can represent updated security vulnerabilities that have been identified by the quantum circuit 154. As such, the output of the threat simulation can include updated weights 142 associated with the edges 136, which represent the communication pathways between the node devices 133.

In block 619, the network segment service 151 can update a network topology graph based at least in part on the updated weights 142. The network segment service 151 can transmit the updated weights 142 and/or the network topology to the management service 118. With the updated weights 142, the network topology graph can be used for further network segmentation optimizations (e.g., FIG. 3). Then, the network segment service 151 proceeds to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-6 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 3-6 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 3-6 show can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same digital computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a digital computing device comprising a digital processor and a digital memory;
a quantum computing device in data communication with the digital computing device, the quantum computing device comprising a quantum processor and a quantum memory;
a first set of machine-readable instructions stored in the digital memory that, when executed by the digital processor, cause the digital computing device to at least:
generate a network topology graph of a computing infrastructure network having a plurality of node devices;
determine a max-cut partition for the network topology graph based at least in part on a plurality of weights assigned to a plurality of communication pathways between the plurality of node devices; and
a second set of machine-readable instructions stored in the quantum memory that, when executed by the quantum processor, cause the quantum computing device to at least:
generate an optimized network segmentation of the network topology graph by executing a quantum approximate optimization algorithm (QAOA) circuit based at least part on the max-cut partition for the network topology graph and the plurality of weights.

2. The system of claim 1, wherein executing the QAOA circuit comprises encoding the max-cut partition for the network topology graph into at least one qubit for the QAOA circuit.

3. The system of claim 1, wherein the max-cut partition comprises a first set of node devices and a second set of node devices from the computing infrastructure network such that a weight summation associated with the max cut partition is maximized.

4. The system of claim 1, wherein the optimized network segmentation comprises a set of optimized network policies for directing network traffic on the computing infrastructure network.

5. The system of claim 1, wherein the first set of machine-readable instructions stored in the digital memory that, when executed by the digital processor, further cause the digital computing device to at least:
execute the optimized network segmentation for the computing infrastructure network, wherein network traffic is directed within the computing infrastructure network based least in part on the optimized network segmentation being executed by at least one of a firewall or a subnetwork for the computing infrastructure network.

6. The system of claim 1, wherein the second set of machine-readable instructions stored in the quantum memory that, when executed by the quantum processor, cause the quantum computing device to at least:
identify a network vulnerability for at least one of the plurality of communication pathways by executing a grover search quantum circuit based at least in part on the optimized network segmentation, the network vulnerability being represented as an updated weight for the at least one of the plurality of communication pathways.

7. The system of claim 1, wherein individual ones of the plurality of weights represent a security risk score for individual ones of the plurality of communication pathways between the plurality of node devices.

8. A method, comprising:
generating a network topology graph of a computing infrastructure network having a plurality of node devices;
determining a max-cut partition for the network topology graph based at least in part on a plurality of weights assigned to a plurality of communication pathways between the plurality of node devices; and
generating an optimized network segmentation of the network topology graph by executing a quantum approximate optimization algorithm (QAOA) circuit on a quantum computing device based at least part on the max-cut partition for the network topology graph and the plurality of weights.

9. The method of claim 8, wherein executing the QAOA circuit comprises encoding the max-cut partition for the network topology graph into at least one qubit for the QAOA circuit.

10. The method of claim 8, wherein the max-cut partition comprises a first set of node devices and a second set of node devices from the computing infrastructure network such that a weight summation associated with the max cut partition is maximized.

11. The method of claim 8, wherein the optimized network segmentation comprises a set of optimized network policies for directing network traffic on the computing infrastructure network.

12. The method of claim 8, further comprising:
executing the optimized network segmentation for the computing infrastructure network, wherein network traffic is directed within the computing infrastructure based least in part on the optimized network segmentation being executed by at least one of a firewall or a subnetwork for the computing infrastructure.

13. The method of claim 8, further comprising:
identify a network vulnerability for at least one of the plurality of communication pathways by executing a grover search quantum circuit on the quantum computing device based at least in part on the optimized network segmentation, the network vulnerability being represented as an updated weight for the at least one of the plurality of communication pathways.

14. The method of claim 8, wherein individual ones of the plurality of weights represent a security risk score for individual ones of the plurality of communication pathways between the plurality of node devices.

15. A non-transitory, computer-readable medium, comprising machine-readable instructions that, when executed by a quantum computing device, cause the quantum computing device to at least:
generate a network topology graph of a computing infrastructure network having a plurality of node devices;
determine a max-cut partition for the network topology graph based at least in part on a plurality of weights assigned to a plurality of communication pathways between the plurality of node devices; and
generate an optimized network segmentation of the network topology graph by executing a quantum approximate optimization algorithm (QAOA) circuit based at least part on the max-cut partition for the network topology graph and the plurality of weights.

16. The non-transitory, computer-readable medium of claim 15, wherein executing the QAOA circuit comprises encoding the max-cut partition for the network topology graph into at least one qubit for the QAOA circuit.

17. The non-transitory, computer-readable medium of claim 15, wherein the max-cut partition comprises a first set of node devices and a second set of node devices from the computing infrastructure network such that a weight summation associated with the max cut partition is maximized.

18. The non-transitory, computer-readable medium of claim 15, wherein the optimized network segmentation comprises a set of optimized network policies for directing network traffic on the computing infrastructure network.

19. The non-transitory, computer-readable medium of claim 15, wherein the machine-readable instructions, when executed by the quantum computing device, further cause the quantum computing device to at least:
transmit an instruction to a computing infrastructure network for executing the optimized network segmentation, wherein network traffic is directed within the computing infrastructure network based least in part on the optimized network segmentation being executed by at least one of a firewall or a subnetwork for the computing infrastructure.

20. The non-transitory, computer-readable medium of claim 15, wherein the machine-readable instructions, when executed by the quantum computing device, cause the quantum computing device to at least:
identify a network vulnerability for at least one of the plurality of communication pathways by executing a grover search quantum circuit based at least in part on the optimized network segmentation, the network vulnerability being represented as an updated weight for the at least one of the plurality of communication pathways.
